(19) United States
(12) Patent Application Publication
(10) Pub. No.: US 2002/0195593 A1
(43) Pub. Date: Dec. 26, 2002

(54) Method and apparatus for lifting of modular furniture

(76) Inventors: William E. Ardrey JR., Cleveland, OK (US); Glenn Robert Nasteff, Bel Air, MD (US); Kevin Bradley Hauck, Baltimore, MD (US); Steven W. Morris, Okemah, OK (US)

Correspondence Address: MCAFEE & TAFT, TENTH FLOOR, TWO LEADERSHIP SQUARE, 211 NORTH ROBINSON, OKLAHOMA CITY, OK, 73102, US

(21) Appl. No.: 09/876,475

(22) Filed: Jun. 7, 2001

(51) Int. Cl. B66F 7/12

(52) U.S. Cl. 254/100

(57) ABSTRACT

A method and apparatus for lifting modular furniture, the apparatus includes an electronically controlled jack and a lifting bar that will engage modular furniture. The lifting apparatus can be interconnected with more than one side for the unit of modular furniture. Each lifting apparatus can be controlled by a master control unit which will cause each lifting apparatus to lift the sides so that modular furniture can be lifted as a unit and maintenance such as painting, and/or removal and replacement of flooring can be accomplished. Synchronous lifting is accomplished by comparing the rate at which each lifting apparatus raises the side and by sending a signal with the master control unit to each lifting apparatus to either stop or adjust its raising rate to insure that tilting, which can place undue stress on certain parts of the modular furniture does not occur. The lifting apparatus includes a jacking device which may be an electronically controlled screw jack, a lifting bar and a plurality of lifting fixtures. The lifting fixtures are supported by the lifting bar which is in turn raised by the jack. The lifting fixtures will engage slots in slotted splines in the modular furniture so that when the jack is raised and/or lowered the modular furniture will move therewith.

The present invention relates to a method and apparatus for maintenance of a floor supporting modular furniture, and more particularly to a method and apparatus for raising and lowering furniture, particularly modular furniture or the like to facilitate the removal and installation of flooring or other maintenance.

Modem office buildings typically have a number of spaces in which modular furniture is utilized to separate the space into several work stations. Modular furniture typically consists of a series of panels secured together to form a number of work stations. The modular furniture also includes accessory hanging tracks, or slotted standards that separate the panels and that connect the panels together. The standards have vertical slots between the upper and lower ends thereof. It is often necessary to move the modular furniture for maintenance, such as but not limited to the removal and replacement of flooring such as floor tiles and/or carpet. To remove the carpet or other flooring, the modular furniture must be raised, the old flooring removed and new flooring or carpet placed beneath the modular furniture. Carpet tiles, or carpet squares are generally used in spaces where modular furniture is utilized. The tiles, which may be about eighteen inches square, can be replaced individually. When the carpet is sufficiently worn and an entire room or a large part of a room is to be recarpeted or refloored, the modular furniture must be moved so that old flooring may be removed and new flooring laid.

There are a number of tools utilized for lifting modular furniture. Examples of those are shown in U.S. Pat. No. 4,846,443 to Collins et al. entitled FLOOR COVERING INSTALLATION TOOL and U.S. Pat. Nos. 5,261,643 and 5,385,335 to Wurdack. Although both disclose tools for lifting modular furniture, both suffer from a number of deficiencies. The existing tools and methods only provide for the removal and replacement of flooring in a small area, since only a part of the furniture can be lifted at once. For example, if a lengthy section of furniture is to be lifted so that the carpet thereunder can be replaced, it is necessary to lift the panel manually with the tools provided therein and to do so several times all along the length of the panel so that all carpet can be replaced. Likewise, if it is desired to lift a multi-sided unit which might contain one or more work stations, a small part thereof is raised, the carpet thereunder is replaced and the lifting tool is removed and moved to another location on the modular furniture. The modular furniture is lifted again to remove and replace flooring thereunder. The process must be repeated over and over until carpet has been replaced under the entire unit of modular furniture.

There are a number of concerns associated with raising only one end of a panel or with raising only a part of a multi-sided unit at a time. The weight of the panel and/or the unit can cause stresses in the modular furniture which can damage the furniture. Further, if only one side and/or a limited number of panels can be lifted, it is time-consuming and costly to remove and replace the flooring or other carpet in large buildings, since the lifting, removal and replacement, and lowering must be repeated over and over until all carpet or other flooring is replaced. Thus, there is a need for a more efficient manner in which to remove the flooring and/or carpet in spaces where modular furniture is used, and more particularly there is a need for a method and apparatus for raising and lowering modular furniture to accommodate maintenance of the floor, or the furniture, including the replacement of flooring.

### SUMMARY OF THE INVENTION

The present invention is directed to a lifting and lowering apparatus for modular furniture of a type including a plurality of panels divided by or connected by spaced-apart slotted standards or slotted splines. The slotted standards have slots defined therein. The lifting apparatus comprises a jacking device, a lifting bar which has a length at least sufficient to span the distance between two adjacent standards, and a plurality of lifting fixtures supported by the lifting bar. The jacking device can be interconnected with the modular furniture, and is preferably an automatic, or electronically controlled jacking device. Thus the jacking device may be energized and, once the jacking device is interconnected with the modular furniture, can be actuated to lift. Interconnecting the jacking device simply requires attaching or connecting the jacking device in such a way so that when the jacking device is actuated, the modular furniture will be lifted or lowered. In the present invention, the jacking device may include a jack having a support at the upper end thereof. To interconnect the jacking device with the panel, the lifting fixtures, which preferably have fingers thereon are interconnected with the modular furniture by inserting the fingers into the slots defined in the slotted standards. The lifting fixtures are disposed about the lifting bar and are preferably slidable therealong so that they can be positioned at any desired slotted standard. The jacking device is actuated and raised so that it will engage the lifting bar. Once the lifting bar is engaged, as the jacking device advances, or is raised, the modular furniture will likewise be raised.

The invention also comprises a system for lifting modular furniture which comprises a plurality of the lifting apparatus of the present invention. The system can be utilized for lifting lengthy sections of modular furniture or for lifting modular furniture that has a plurality of sides. Thus, the system may include at least one apparatus positioned on more than one side of the modular furniture. As described above, the jacking device of each lifting apparatus may be interconnected with the modular furniture. The jacking devices can be actuated so that the modular furniture is raised as a unit. In other words, the jacking devices will be actuated so that the unit will lift from the floor as a unit rather than lifting one side at a time wherein a portion of the unit rests on the floor as opposed to being lifted off the ground.

The method of the present invention may thus comprise placing jacking devices on a plurality of sides of multi-sided modular furniture, interconnecting the jacking devices with the plurality of sides and lifting the modular furniture as a unit. Preferably, the jacking devices synchronously raise and lower the unit. The jacking devices may be operated with a master control that is encoded to operate all of the jacking devices that will be connected to a unit of modular furniture.

When the modular furniture is raised, maintenance of any type may be performed. For example, flooring beneath the modular furniture such as carpet may be removed and replaced while the furniture is lifted. The invention may also be used to lift modular furniture to allow the removal and replacement of access flooring. The furniture may then be lowered. Other maintenance can be performed such as painting and/or other maintenance to the furniture itself. Thus, the invention provides a method and apparatus for lifting modular furniture that enables the removal and replacement of flooring in large work areas in a timely and cost-efficient manner. Because large units may be lifted at once by a single operator with a master control, jobs can be performed with fewer people and can be performed more quickly since all of the carpeting or flooring beneath the unit can be replaced at once. Additional objects and advantages of the present invention will become apparent to those skilled in the art when the following description and claims are taken in conjunction with the accompanying drawings.

### BRIEF DESCRIPTION OF THE DRAWINGS

FIG. 1 is a perspective view showing the left and front of the jacking device of the present invention. The outer housing is shown in partial section.

FIG. 2 is a perspective view showing the right and rear of the jacking device of the present invention. The outer housing is shown in partial section.

FIG. 3 is a front view of a portion of the jacking device without the housing, and shows the jacking device in a raised or lifted position.

FIG. 4 is a section view taken from line 4-4 of FIG. 2.

FIG. 5 is a view from line 5-5 of FIG. 3.

FIG. 6 is a view from line 6-6 of FIG. 3.

FIG. 7 shows a lifting bar of the present invention.

FIG. 8 is a view from line 8-8 of FIG. 7.

FIG. 9 shows a side of modular furniture including a plurality of panels and a plurality of slotted supports. The jacking device is schematically represented.

FIG. 10 shows a view similar to that in FIG. 9 except that the modular furniture has been lifted with the jacking device of the present invention.

FIG. 11 schematically shows a top view of a multi-sided modular furniture with jacks positioned at each side and lifting bars engaging the slotted standards at each side.

FIG. 12 shows a comer of a unit of modular furniture which has been lifted utilizing the apparatus of the present invention.

FIG. 13 schematically shows a top view of a unit of modular furniture which defines a plurality of work stations and schematically shows jacking devices positioned in a variety of locations that will allow the entire unit to be lifted.

FIG. 14 is a block diagram of the controller of the present invention.

FIG. 15 shows the front panel of the controller of the present invention.

FIG. 16 is a block diagram of the jacking device of the present invention.

FIGS. 17 and 18 are flow charts showing the operations of a system of the present invention.

### DETAILED DESCRIPTION OF A PREFERRED EMBODIMENT

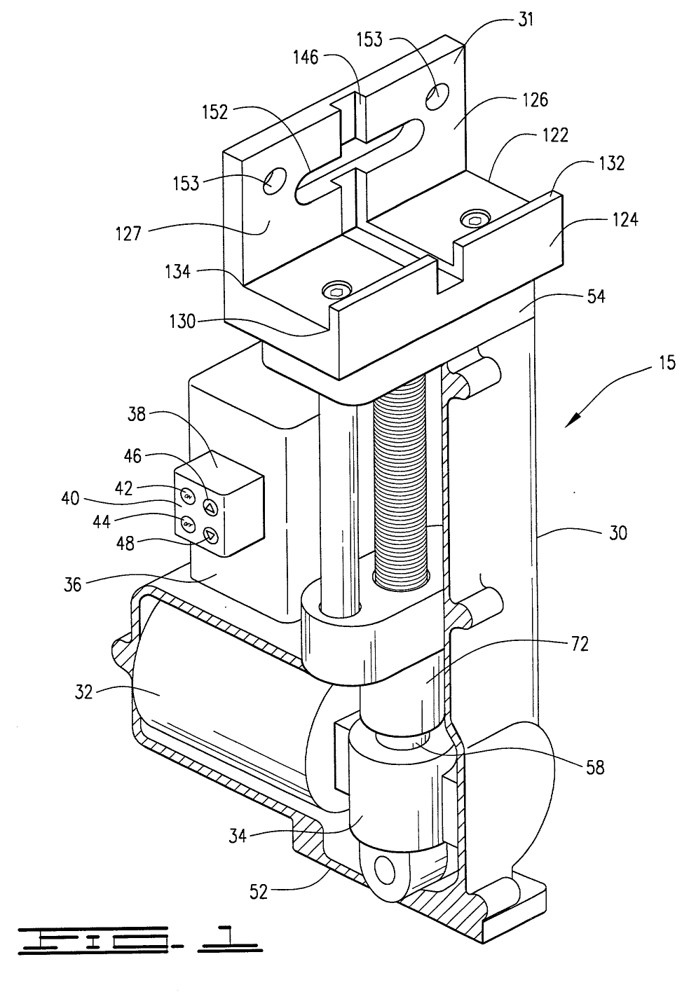

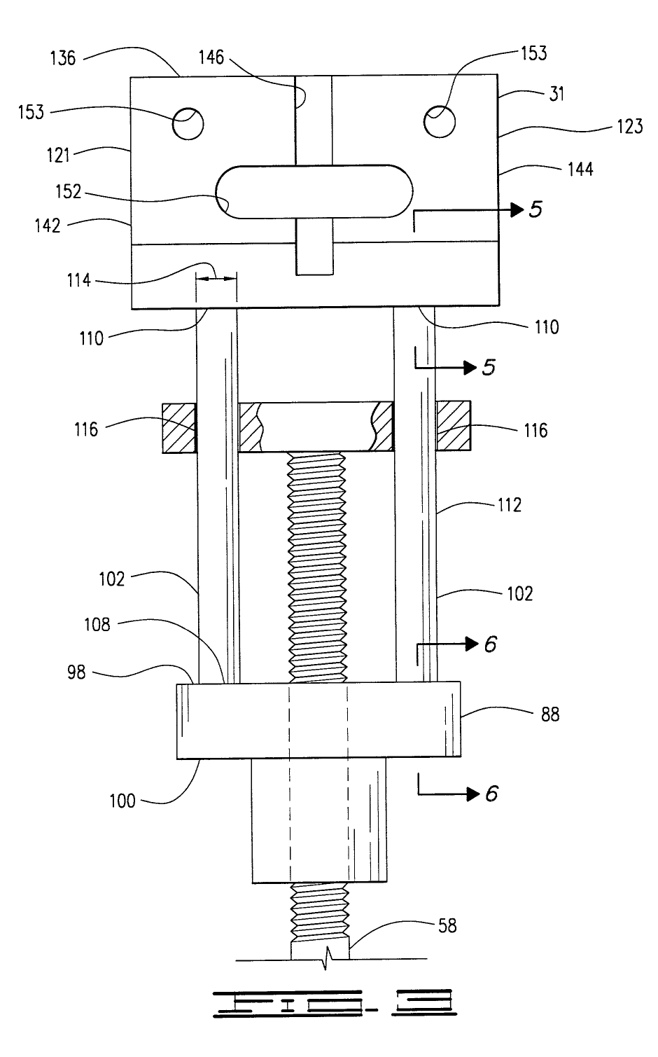

Referring now to the drawings, a lifting apparatus or lifting assembly 10 for raising and/or lowering modular furniture is shown and described. The lifting assembly 10 may include a jacking device 15 adapted to engage a lifting bar 20. The lifting bar 20 will support lifting fixtures 25. Jacking device 15 is shown more clearly in FIGS. 1-4.

As shown therein, jacking device 15 preferably comprises an automatic, or electronically controlled ball screw jack 30 having a lift support 31. Although an electronically controlled ball screw jack is depicted in the preferred embodiment, other types of jacks may be utilized with the present invention.

Jack 30 may comprise a motor and gear box arrangement including a motor 32 and a gear box 34 connected in any manner known in the art. Motor 32 may be any type of AC or DC motor, but in the preferred embodiment is a reversible variable speed DC motor. Jack 30 further includes a power source 36 which is preferably a battery 36 connected to the motor and connected to a control box 38. Control box 38 has a panel 40 thereon for control of jack 30, and for communicating with a master control unit as will be explained in more detail herein. The control panel includes an ON button 42, an OFF button 44 and UP and DOWN buttons 46 and 48 respectively.

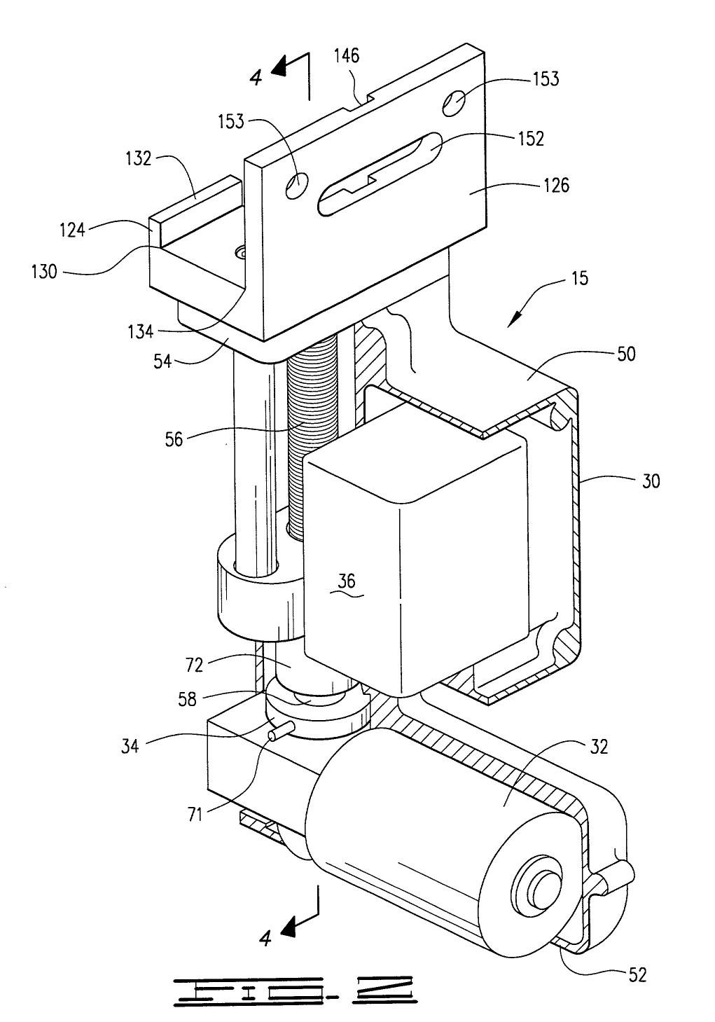

As seen in FIGS. 1 and 2, the jacking device has an outer housing 50. Outer housing 50 may be comprised of aluminum or other material, and may be a multiple piece housing that is bolted or otherwise connected at various locations. As is apparent from the drawings, numerous bosses are included for bolting or other connection. Housing 50 may completely enclose the working components of the jack but will have an opening therein to provide access to the control panel 40. Housing 50 has a base 54 which will rest on a ground or other support surface, and has a removable upper cap 54. Cap 54 may be attached utilizing bolts or other removable connectors or by any other means known in the art. The upper cap is preferably a generally rectangularly shaped upper cap.

A ball screw or guide screw 56 is driven by the motor gear box arrangement 32, 34. Ball screw 56, which may also be referred to as a lift screw, extends upwardly from and is driven by motor 32 and gear box 34. Ball screw 56 has an unthreaded portion 58 where the ball screw 56 exits gear box 34. Ball screw 56 has threads 60 defined thereon above unthreaded portion 58. Threads 60 are defined on an outer surface 61 of ball screw 56, and have a lower end 62 and an upper end 64. Ball screw 60 likewise has an unthreaded, preferably cylindrically shaped upper end 66. Upper end 66 is received in a bearing 68 disposed in an opening 70 defined in upper cap 54 of housing 50. A sensor 71 for sensing the rotational speed of lift screw 56 extends through gear box 34. Sensor 71 may be a reed switch or Hall effect sensor, or any other type of sensor known in the art. Upper end 66 is rotatable in bearing 68.

An internally threaded traveling support 72 is threadedly disposed about threaded portion 60. Traveling support 72 has a lower end 74 and an upper end 76, and has a generally cylindrical portion 78. Cylindrical portion 78 has lower end 74 and an upper end 80. An extension 82 extends upwardly from cylindrical portion 78 and has external threads 84 defined thereon. Traveling support 72 has threads 86 defined on the inner surface thereof to threadedly engage threaded portion 60 of guide screw 56 and is threadedly connected with threads 84 to a support block 88.

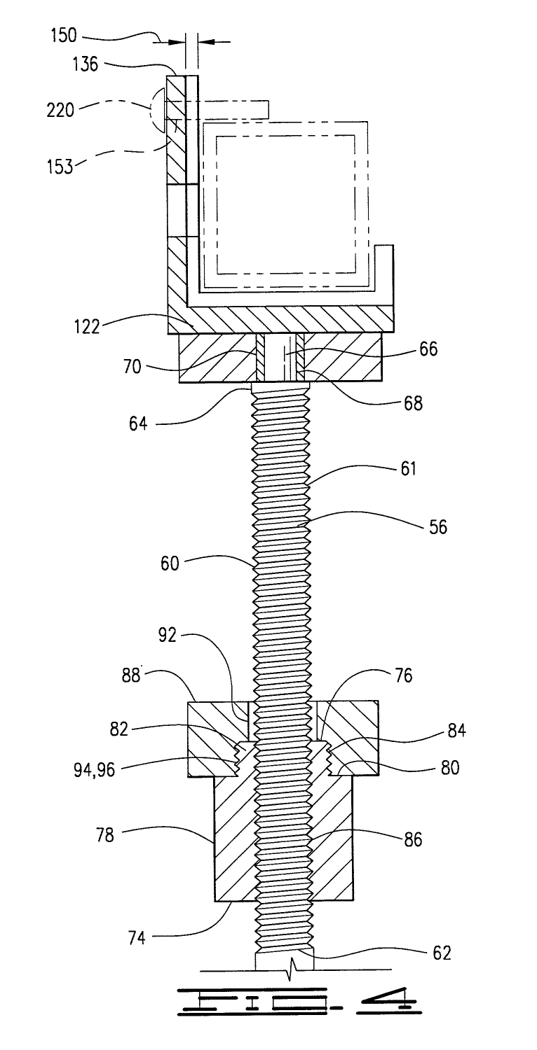

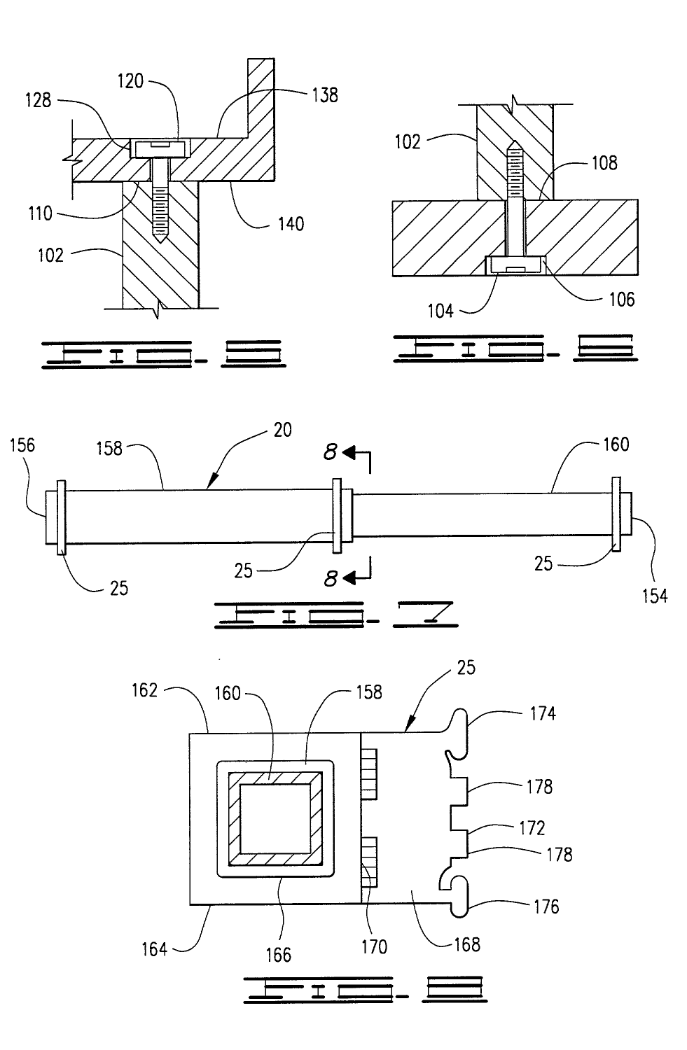

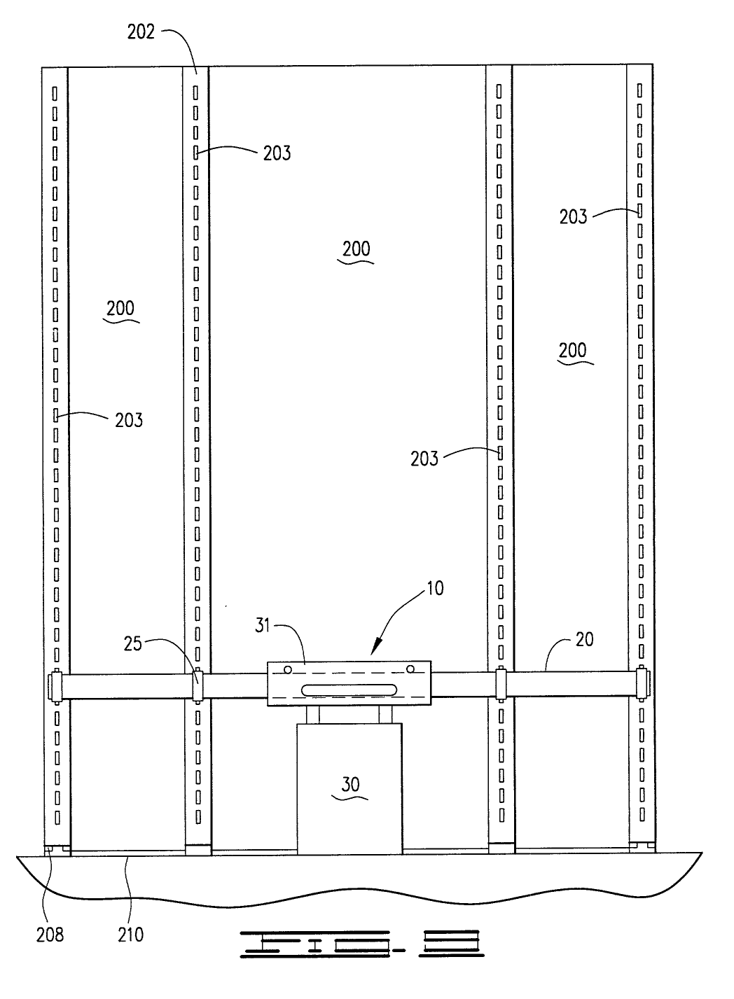

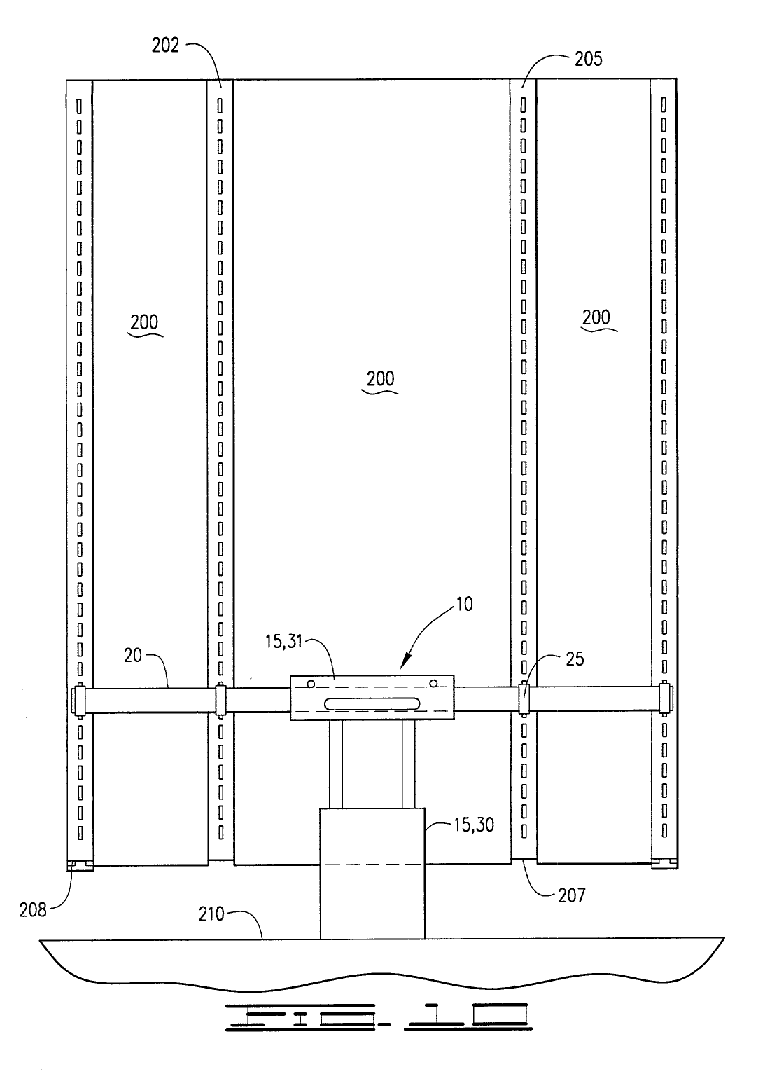

Support block 88 has a central opening 90 defined therethrough. Central opening 90 has an unthreaded upper portion 92 and a threaded lower portion 94 having threads 96 for connection with threads 84 on traveling support 72. Support block 88 has upper end 98, lower end 100 and is preferably generally elliptically or oval shaped. A pair of support rods 102 are connected to and extend upwardly from support block 88. As shown in FIG. 4B, support rods 102 are preferably parallel support rods and are connected at the lower ends thereof to support block 88. In the embodiment shown, the lower end of each support rod is tapped and a bolt or other threaded connector extends through support block 88 into the inner threads of support rods 102. Preferably, support rods are connected with bolts 104 that are disposed in a counterbore 106 having a sufficient depth so that the bolt 104 does not extend beyond lower end 100.

Support rods 102 have a lower end 108 and an upper end 110. As set forth above, lower ends 108 are internally threaded so that a threaded connector may be received therein to connect the rods to support block 88. Support rods 102 have an outer surface 112 that defines an outer diameter 114. Upper cap 54 of housing 50 has openings 116 defined therethrough. Rods 102 extend through openings 116 which have a diameter greater than outer diameter 114 so that rods 102 may move freely therethrough. As shown in FIG. 4A, rods 102 are tapped or threaded at upper end 110 thereof so that a bolt or other threaded connector 120 may be received and threaded therein to connect lift support 31 thereto.

Lift support 31 has first and second ends 121 and 123, and comprises a support plate 122 having forward and rear flanges 124 and 126 extending upwardly therefrom preferably at right angles. Rear flange 126 has a forward face, or surface 127. As shown in FIG. 4A, support plate 122 preferably has counterbores 128 therein for receiving the heads of connectors 120.

Forward flange 124 extends upwardly from a lower edge 130 to an upper edge 132. Likewise, rear flange 126 extends upwardly from its lower edge 134 to its upper edge 136. Support plate 122 has upper and lower surfaces 138 and 148 respectively.

A groove or slot 146 is defined in lift support 31 between the ends 121 and 123 thereof. Groove 146 is preferably positioned centrally between ends 142 and 144 and more preferably is a midpoint between rods 102. Groove 146 is defined in forward surface 127 of rear flange 126 and is defined in upper surface 138 of support plate 122. Groove 146 preferably has a depth 150 and extends all the way through forward flange 124. Support channel 31 may also include a handle grip opening 152 through the rear flange thereof to provide for lifting and moving the jacking device to desired locations. Channel 31 may also have openings 153 defined through flange 126 for receipt of fasteners to hold lifting bar 20.

Lifting bar 20 is preferably an expandable or variable-length lifting bar having first and second ends 154 and 156. Lifting bar 20 preferably has a generally rectangularly shaped cross-section and is comprised of an outer tube or outer bar 158 and an inner tube or inner bar 160 slidably received therein. Although the lifting bar shown and described herein is a retractable, or variable-length bar, obviously a bar of fixed length having any desired length may be used.

Lifting fixtures 25 are supported by lifting bar 20. If desired, lifting bar 20 may have lifting fixtures 25 fixedly attached at the ends thereof. Additional lifting fixtures may be placed on lifting bar 20 by sliding tube 160 from outer bar 158 and placing lifting fixtures 25 thereon, and then reinserting inner bar 160 into outer bar 158. It is not necessary that fixtures 25 be attached to the ends 154 and 156 and if desired, lifting fixtures 25 can simply be slipped over tube 20 and are slidable therealong. Lifting fixtures 25 include a body portion 162 having an outer periphery 164 and an inner periphery 166. Inner periphery 166 is sized so that fixtures 25 may be disposed about and are slidable along lifting bar 20. Body portion 162 is connected to a lifting portion 168 and is preferably hingedly connected to lifting portion 168 with a hinge 170. Lifting portion 168 extends forward from body portion 162 and has a plurality of fingers 172 extending therefrom. Fingers 172 may include upper and lower hook-shaped fingers 174 and 176 respectively and intermediate straight fingers 178. The fingers are adapted to be inserted into slots defined in slotted splines or slotted standards used in modular furniture as will be described in more detail hereinbelow.

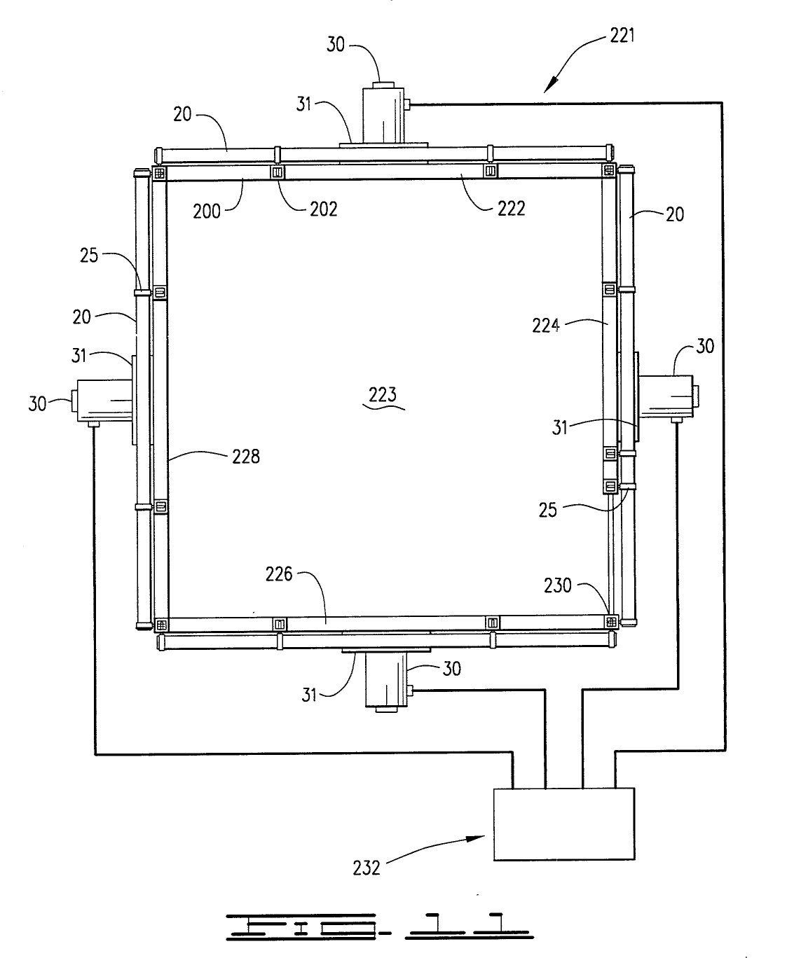

The method of operation of the lifting apparatus for lifting modular furniture may be described with reference to the drawings and more particularly with reference to drawings 9-18. Modular furniture of the type contemplated herein typically includes a plurality of panels 200 connected by a plurality of slotted standards or slotted splines 202. Slotted standards 202 define a plurality of vertically aligned slots 203. Standards 202 have upper end 205 and lower end 207 and may include corner splines 204 and intermediate splines 206. The slotted standards 202 may go all the way to the floor, or may have a space below the lower end thereof, and as depicted in FIGS. 9 and 10 may include feet 208 extending from the ends thereof to engage a floor or ground surface 210. The type of modular furniture described herein is that which is routinely utilized in large office spaces to create a plurality of work stations. The modular furniture must periodically be raised for a variety of reasons including maintenance, such as painting, and the removal or replacement of flooring, such as floor tiles or carpet.

Referring now to FIG. 9, to raise modular furniture, a jacking device including jack 30 and lift support 31 is positioned proximate the modular furniture. Lifting fixtures 25 are disposed about lifting bar 20 and the lifting bar 20 with lifting fixtures 25 supported thereby are located at a desired height on the slotted standard 202. Fingers 172 are then inserted into slots 203. As is apparent from the drawings, lifting bar 20 may be of such an expandable length that it will span the distance between at least two adjacent slotted standards 202 and in the case of the lifting bar shown in FIG. 9 will expand such that lifting fixtures 25 supported thereby can be inserted into the slots in four different standards 202. Once the lifting fingers have been inserted into the slots, the jacking device 15 can be energized by depressing the ON button 42.

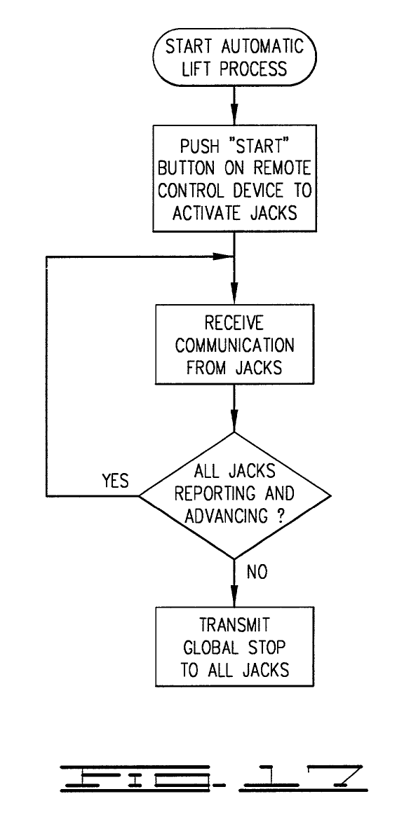

As shown in the block diagram in FIG. 16, control box 38 includes a transceiver 212, an encoder/decoder 214 which is preferably a digital encoder/decoder, a microcontroller 216 and a DC motor control 218 to operate and control motor 32. Sensor 71 is also connected to control box 38. Although the present invention is not limited to these elements or to any particular implementation of these, one example of transceiver 212 is of a type known in the art, such as for example, ABACOM's AM-RTO-315; however other implementations may be used as known in the art. The decoder/encoder 214, the microcontroller 216, the motor controller 218 and the sensor 71 may also be of or for any suitable types or implementations now or hereafter known or developed in the art. Non-limiting examples of present particular implementations include:

| | |
|---|---|
| encoder/decoder 214 | Holtek HT12E/HT12D |
| microcontroller 216 | Philips 8051 |
| motor 32 | Motion Systems 73462 |

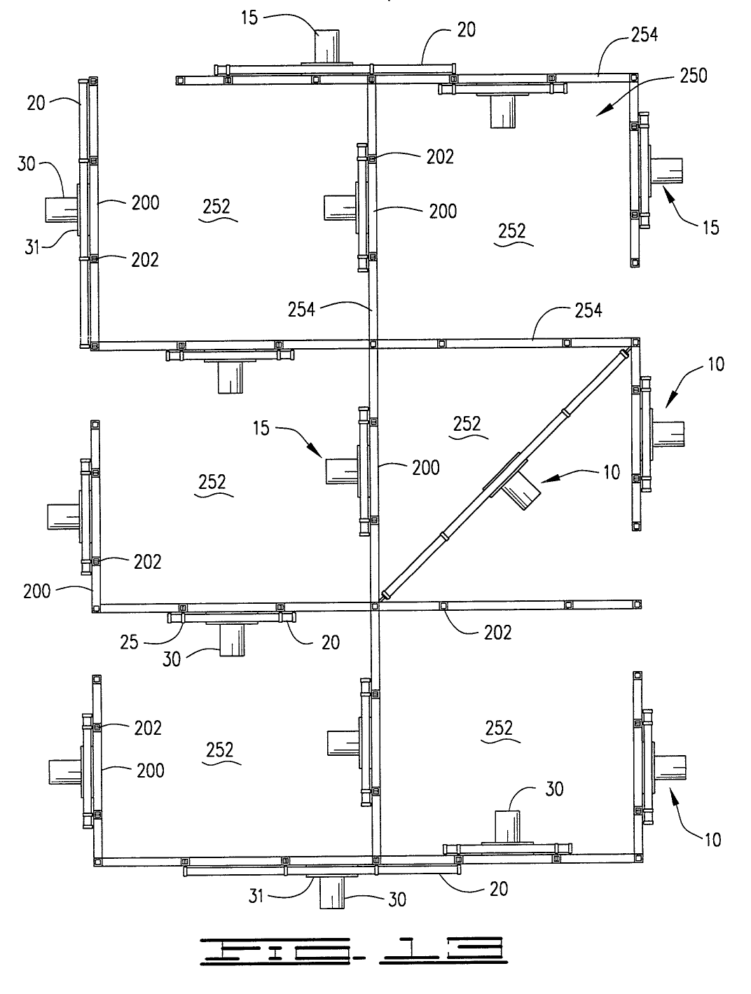

The microcontroller 216 is programmed in suitable manner to perform or to control the performance of steps described herein with regard to operation of the control box 38 and its jacking device 15. The motor controller 218 is implemented to interface between the microcontroller 216 and the motor 32. Once control box 38 has been switched to the ON position, the UP button 46 may be depressed which will actuate the microcontroller 216 to send one or more control signals to the motor controller 218 that then causes the motor and gear box to rotate guide screw 56 in the appropriate direction. The rotation of the guide screw will cause traveling support 72 to move upwardly which will cause support block 88 and support rods 102 to move upwardly as well. Support channel 122 will thus be raised until it engages lifting bar 20. The UP button can be released, and jack 30 will stop, but unless the OFF button 44 is pushed, jack 30 will remain energized. A pair of fasteners 220 (FIG. 4) may then be inserted through openings 153 to help hold lifting bar 20 in place. Fasteners 220 are preferably of a type that can be retracted so that lifting bar 20 can be easily placed on lift support 31, but that will be retained in hole 153. Once lifting bar 20 is placed on lift support 31, fasteners 220 can be released so that they will extend over lift bar 20, as shown in FIG. 4, to assist in maintaining lifting bar 20 in place. If jack 30 is placed such that a slotted standard is positioned immediately adjacent thereto, or if it is desired to use only one lifting fixture, a support bar with one lifting fixture 25 thereon can be positioned so that lifting fixture 25 rests in groove 146. Once lift support 31 has engaged lifting bar 20, the modular furniture can be raised by again pressing the UP button 46 so that lifting fixtures 25 will engage the slotted standards and will raise the modular furniture as depicted in FIGS. 10 and 12.

FIG. 12 shows a corner of the modular furniture with which the present invention is intended to be used. As is apparent therein, lifting bars 20 and fixtures 25 can be placed at any height so that lifting forces can be applied to a plurality of sides of a multi-sided unit. Once the modular furniture has been raised to a desired height, the lifting is stopped simply by releasing UP button 46, allowing its spring-loaded or other resilient switch to open (FIG. 16), and power can be shut off simply by pushing OFF button 44 to open the responsive power switch (FIG. 16). If carpet or other floor removal is the desired operation, the carpet beneath the jacking device will have been removed prior to the time the jacking device is placed on the floor surface. Once the modular furniture is lifted, carpet or other flooring from directly therebeneath can be removed and new carpet can be replaced. The carpet, or flooring that will cover the space where the jacking devices are placed may be installed after the jacks are removed, or can simply have the edge thereof turned upwardly behind the jack, so that upon removal of the jack, the carpet will cover the portion of the floor where the jack was located. The modular furniture can be lowered simply by once again actuating jacking device 15 by pressing the ON button 42 if power is off and pushing the DOWN button 48 to close its resilient switch (FIG. 16) so that the modular furniture is lowered until it reaches the floor. The DOWN button will continue to be depressed until lift support 31 is no longer engaged with the lifting bar 20 at which time the DOWN button 48 is released and the lifting bar 20 can be removed.

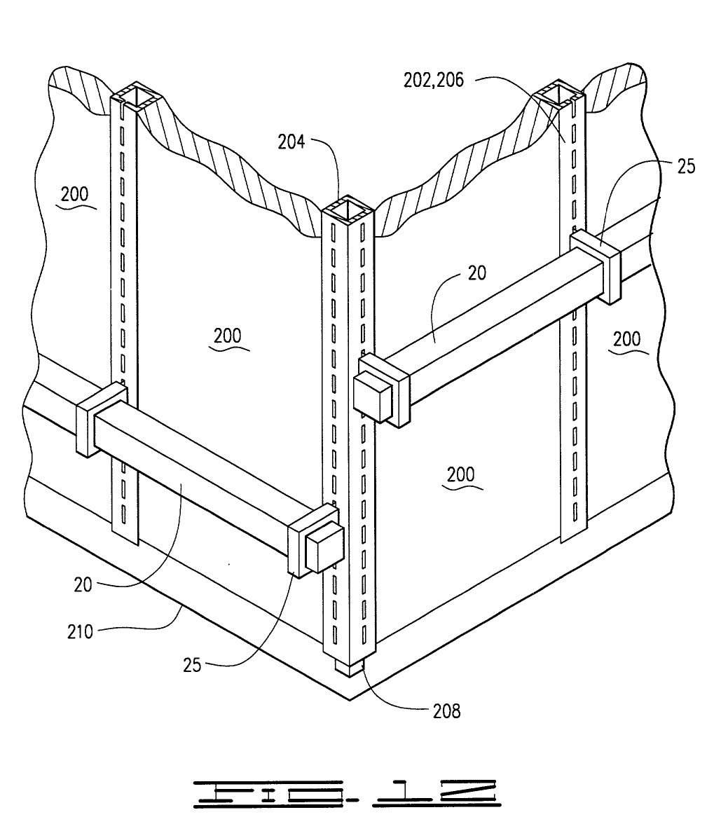

More than one lifting apparatus 10 of the present invention may be used to raise a large number of panels connected in a straight line, and/or to raise units of modular furniture. For example, FIG. 11 shows a multi-sided unit, namely a four-sided unit of modular furniture 221 that defines a single work station 223. Unit 221 has four sides 222, 224, 226 and 228 respectively. Side 226 has a doorway 230 defined therein. Each side is made up of a plurality of panels 200 and slotted splines or standards 202. Unit 221 can be lifted at once, as a unit, utilizing a plurality of lifting apparatus 10. As described hereinabove, lifting bars 20 with lifting fixtures 25 attached thereto can be located and interconnected with unit 221 by inserting fingers 172 on lifting fixtures into the slots defined in the slotted splines 202. Each jacking device 15 can be actuated by pressing ON button 42 on its respective control box and then pushing the respective UP button 46 so that lift support 31 of each lifting apparatus 10 engages respective lifting bars 20. Once lifting bars 20 are engaged, pins or bolts 220 on each jacking device 15 can be utilized to hold respective lifting bars 20 to lift supports 31. Once all of the jacking devices 15 have been energized and raised to a level such that lift supports 31 engage the corresponding or respective lifting bars 20, the power will remain on but preferably no independent further lifting by individual jacking devices will occur.

To assure that unit 221 is lifted as a unit, and that the lifting apparatus 10 provides for synchronous lifting of each side, the jacks 30 may be actuated to lift, and then to lower by a master control unit 232. Master control unit 232 is shown in the block diagram in FIG. 14 and may include a transceiver 234, an encoder 236, which is preferably a digital encoder/decoder and a microcontroller 238 (suitably programmed to perform or control steps of operation consistent with the explanation herein). The control panel on the master control unit preferably includes ON, OFF, UP and DOWN buttons 240, 242, 244 and 246 respectively for operating switches shown in FIG. 14. The foregoing elements may be implemented in any suitable manner as readily known in the art, non-limiting examples of which include the same types of devices as referred to above for corresponding components in the control box 38 of FIG. 16. Master control unit 232 can be programmed or operated (e.g., at different frequencies) to operate only certain jacks in the event that several units of modular furniture are being lifted and lowered at one time by different operators using different jacks and different master control units.

Communications between the master control unit 232 and the control boxes on each jack 30 may be wireless, or may be via wired connections. Once all of the jacking devices 15 are interconnected with the modular furniture and the ON button 42 on the control box 38 at each jack 30 has been activated, lifting of the unit can occur simply by depressing ON button 240 and then depressing the UP button 244 on master control unit 232. This causes the microcontroller 238 to send one or more signals actuating the encoder/decoder 236 and the transceiver 234 (FIG. 14, or suitable wire interface for the wired connection illustrated in FIG. 11) to communicate control signals to the control boxes 38. Each control box 38 receives, decodes and responds to control signals intended for it, including causing the respective motor control 218 to drive the respective motor 32 to lift the respective portion of the modular furniture. The interconnecting of the jacking devices to the modular furniture simply means that the jacking devices are attached and/or connected in a way so as to raise the modular furniture when the jacking device is actuated. The interconnecting here comprises raising each jack 30 so that support 31 engages the lifting bar 20 which has lifting fixtures 25 supported thereon. Jacking devices 15 are initially calibrated so that each jack 30 has the same raising rate. In other words, each jack 30 will raise or lift its respective support channel 31 and lifting bar 20 at the same rate of speed as the other individual jacks 30. Thus, the present invention provides for a system for lifting modular furniture which includes placing a lifting apparatus on a plurality of sides of a multi-sided unit, and actuating the jacking devices 15 so that the modular furniture will be lifted as a unit, and preferably so that each side will be raised at the same raising rate. Each jacking device will be monitored, to insure that each jack 30 is operating to lift or lower depending on the desired operation. If a jack is not operating, all of the jacking devices 15 may be automatically shut down. The operation of each jacking device 15 is determined by its respective sensor 71 and microcontroller 216, which generates one or more signals to actuate the respective encoder/decoder 214 and transceiver 212 (or other communication interface) to send signals to the master control unit 232. The rate at which each jack is moving, or the rate at which each side is being lifted may also be monitored and continuously compared with a desired raising rate to insure that the multi-sided modular furniture is being lifted as a unit, and preferably that synchronous lifting is occurring.

Thus, one manner of insuring lifting the modular furniture as a unit is by sensing an operating parameter related to the lifting of the modular furniture, communicating that operating parameter to the controller and then determining in the controller whether or not the operating parameters of each jacking device are the same or substantially the same. If not, the master control unit can communicate with individual jacks to adjust the rate at which the jack is lifting or lowering, or to shut each jack down if the monitored parameter varies by more than a desired amount. The operating parameters that might be measured are for example the speed at which the panel is being lifted. Other parameters might include the time it takes for the panel to reach a certain identified point or the distance off the floor the panel reaches.

The sensor 71 utilized in the preferred embodiment is a shaft position sensor which is essentially a proximity switch that activates a pulse to the control electronics for each rotation of the ball screw. Each rotation of ball screw 56 translates into a predetermined amount of linear motion of support block 88, and thus lift support 31. The speed of rotation thus determines the lifting or raising rate of each jacking device. Control box 38 at each jack 30 receives information from sensor 71, and communicates the information to master control unit 232. For example, the sensor 71 at each jack may sense whether the jack is advancing either up or down. If control box 38 receives an RPM signal, the jack will continue to advance. If no signal is received, an error code will be sent to the controller in remote control 232 which will send a shut-down signal to all jacks.

Alternatively, each jacking device may communicate information to the microcontroller to indicate a speed of rotation. The microcontroller in master control unit 232 may compare the speed of rotation of each lift screw 56 to a predetermined rate, to determine whether the raising rates of the jacking devices 15 are substantially the same and that the modular furniture is being lifted as a unit. As described above, if all jacks 30 are not reporting and advancing, master control unit 232 will transmit a global communication to stop all jacks. If all jacks 30 are reporting and the master control unit 232 receives a signal indicating that one or more jacks are not advancing at the predetermined rate, master control unit 232 will send a stop signal, or if desired, send a signal to adjust the speed of the variant jacks 30 so that each advances at the same rate. The present invention thus provides a method and apparatus for lifting modular furniture as a unit and for synchronously lifting a plurality of sides of a multi-sided unit.

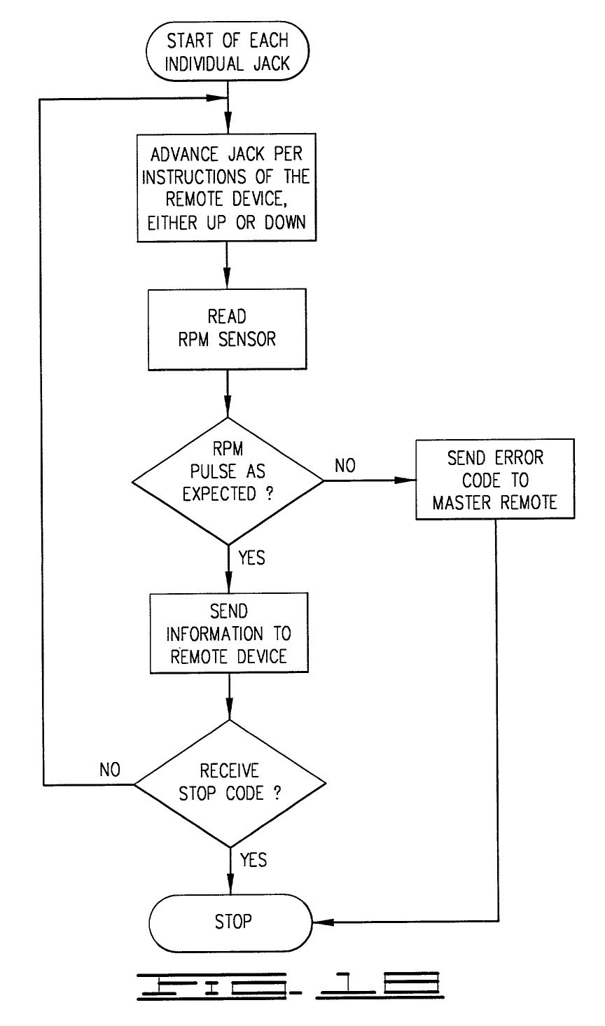

The operation is easily understood with reference to the flow chart shown in FIG. 17. The flow chart shows the process after each individual jack 30 has been raised or lifted so that each respective lift support 31 has engaged its respective support bar 20 which has lifting fixtures 25 disposed thereon that have been located to interconnect with slotted standards 202 by inserting fingers 172 in slots 203. The automatic lift process is started by simply pressing the UP button 244 on the remote control device 232 (assuming the ON button 240 has already been pushed to engage the device 232) to activate or actuate jacks 30 to begin lifting as described above. Master control unit 232 will receive communications from the jacks as described above. The microcontroller 238 will then compare the information from the jacks to determine if all jacks are reporting and advancing. If the jacks are advancing, the operation will continue until a desired height has been reached and the operator releases the UP button 244. If, however, the microcontroller 238 has received information indicating that all jacks are not reporting and advancing, a global stop may be transmitted to all jacks as described above. The process may be modified so that the microcontroller 238 can, if all jacks are reporting but are reporting that the jacks are not advancing at a predetermined rate, send one or more signals to the jacks to adjust the rotational rate of the screws so that each jack is advancing (either up or down) at substantially the same rate or a rate within a desired range.

The flow chart of FIG. 18 also shows the process for each jack. As set forth above, each individual jack will already be energized. The jacks will advance per the instructions provided by the master control unit 232 either up or down as implemented by the respective microcontroller 216. The jack will read the RPM sensor 71 and if it receives an RPM pulse as expected, it will continue to advance. If no RPM pulse is received, an error code will be sent to the master control unit which will then, as set forth in the prior flow chart transmit a global stop to all jacks, as previously described. If the RPM pulse is received, advancement of the jack (lifting or lowering) will continue until it receives a stop code from the master control unit, such as when the operator releases the UP button or the DOWN button or an error is detected, as described above.

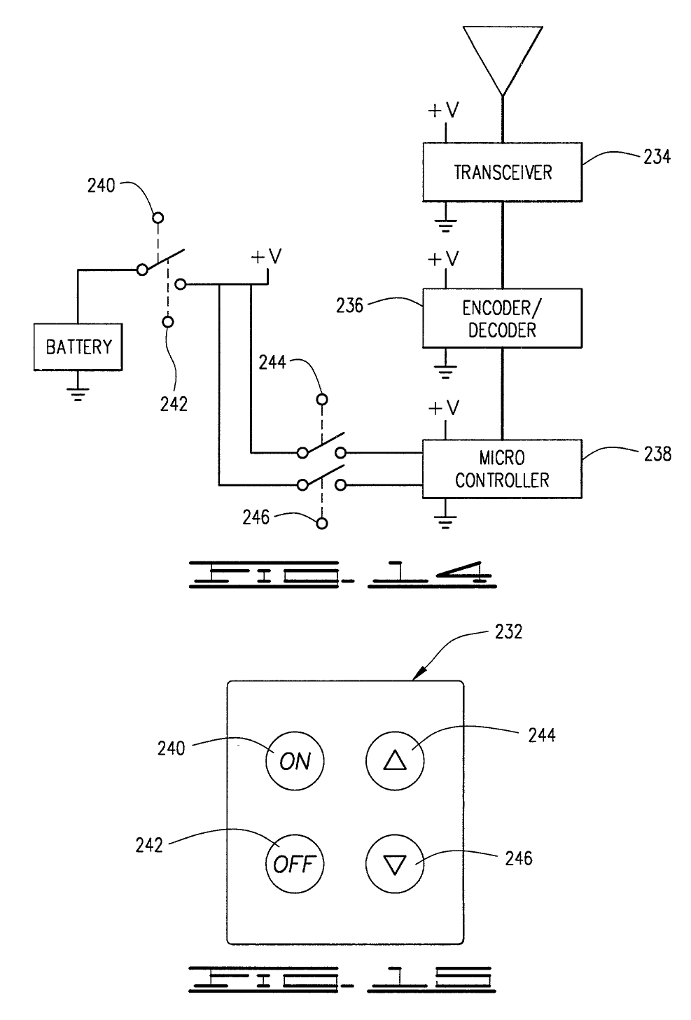

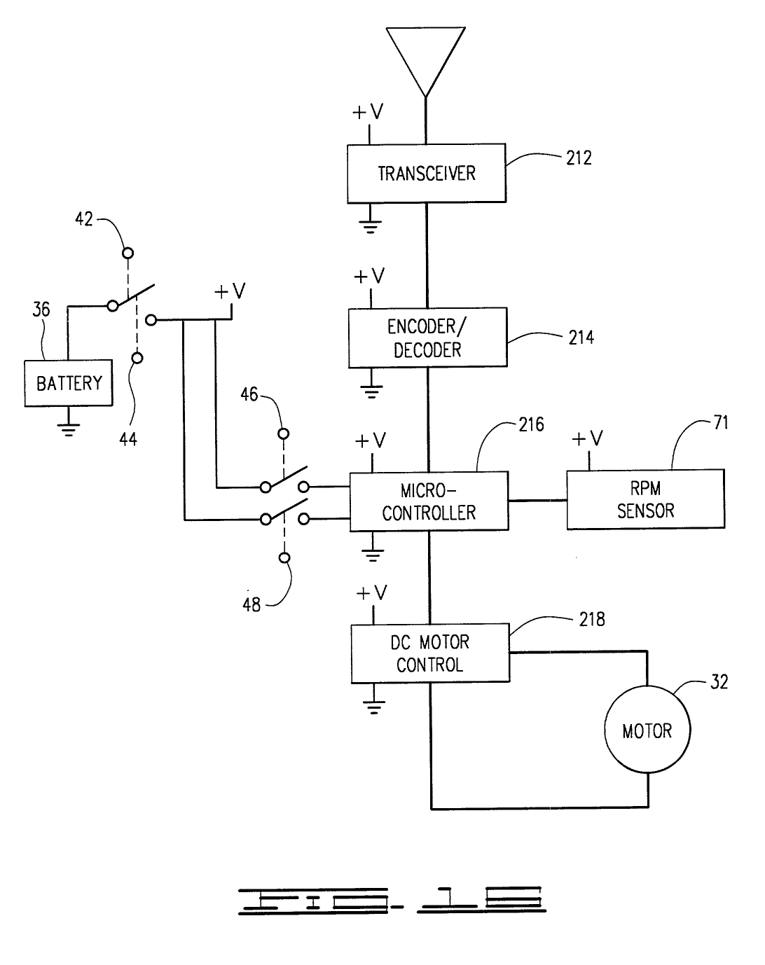

FIG. 11 shows another example of a unit 250 of modular furniture and makes it clear that the unit may comprise a plurality of work stations. Thus “unit” as referred to herein is simply intended to indicate modular furniture having more than one side wherein the sides are connected to one another. Thus, a unit of modular furniture may define one work station as in FIG. 11, or as in FIG. 13 may define a plurality of work stations. FIG. 13 shows multi-sided unit 250 that defines a plurality of work stations 252. FIG. 13 is a top plan view and shows work stations 252 each defined by a plurality of sides 254 wherein each of the sides 254 includes panels 200 connected by slotted standards or slotted splines 202. A plurality of jacking devices 15 may be positioned strategically proximate the sides of the work stations defined by unit 250. Lifting bars can be positioned to interconnect with slots 203 in standards 202 and each jacking device can be actuated to engage its corresponding lifting bar 20. As indicated in FIG. 13, because the lifting fixtures are hinged, the jacks may be positioned so that a lifting bar can extend diagonally across a work station and the lifting fixture pivoted about the hinge to engage slots 203 in standards 202. Once each jack 30 has been energized by pressing the ON button on the control panel and raised to engage its corresponding lifting bar 20, the entire unit 250 may be lifted by simply pressing ON button 240 on master control unit 232 and then depressing UP button 246. All of the jacks 30 will cause the respective lifting bars 20 and thus the lifting fixtures 25 to move upwardly which will raise the unit 250 from the ground or floor surface. Lifting can be stopped when a desired height is reached, and carpet or other flooring from therebeneath can be removed or other maintenance can be performed such as painting. As described hereinabove, if floor removal is desired, the flooring where the jacks are to be placed will be removed in advance. New carpet can be positioned so that once the jacks are removed the carpet can be laid to cover the space where the jacks were resting. Jacks 30 are monitored in the manner herein described so that if any jacks are not advancing or the raising rate of one or more of the jacks 30 varies too greatly, all of the jacks 30 can be stopped or the master control unit can send a signal to speed up or slow down the variant jacks. The method thus provides for the lifting and lowering of modular furniture as a unit, and for synchronous raising and lowering of modular furniture to provide for more efficient maintenance of modular furniture and to provide for more efficient removal and replacement of carpet or other flooring.

Thus, the present invention is well adapted to attain the objects and advantages mentioned herein as well as those which are inherent. While numerous changes may be made by those skilled in the art, such changes are encompassed within the spirit of the invention as defined by the appended claims.

What is claimed is:

1. Lifting apparatus for lifting modular furniture, the modular furniture including a plurality of spaced-apart slotted standards having slots defined therein and at least one panel supported by said standards, the apparatus comprising:
a jacking device;
a lifting bar having a length at least sufficient to span the distance between two adjacent standards;
a plurality of lifting fixtures supported by said lifting bar for engaging a plurality of said slotted standards, wherein said jacking device will engage and raise said lifting bar to lift said modular furniture when said plurality of lifting fixtures are engaged with said plurality of slotted standards.

2. A system for lifting modular furniture, wherein said modular furniture has a plurality of sides, the system comprising:
a plurality of the apparatus of claim 1, wherein more than one side of said modular furniture has an apparatus of claim 1 positioned adjacent thereto to engage slotted standards in said more than one side of said modular furniture.

3. The system of claim 2 wherein said jacking devices are automatic jacking devices, the system further comprising:
a remote control for communicating with said jacking devices, wherein said jacking devices can be actuated to lift or lower said lifting bar with said remote control.

4. The system of claim 3 wherein said jacking devices are synchronized so that said jacking device will lift and lower the sides on which said jacking devices are placed at substantially the same rate.

5. The system of claim 3, wherein said jacking device will raise and lower said modular furniture as a unit.

6. The apparatus of claim 1, wherein said lifting bar is a variable-length bar adapted to be expanded or retracted to different lengths.

7. The apparatus of claim 6, said lifting bar comprising:
an outer tube; and
an inner tube slidably received in said outer tube, wherein said inner tube may be retracted into or withdrawn from said outer tube to vary the length of said lifting bar.

8. The apparatus of claim 1, wherein said lifting fixtures are slidable along said lifting bar so that said fixtures may be positioned to engage a desired slotted standard.

9. The apparatus of claim 1, wherein said lifting fixtures comprise:
a body portion disposed about said lifting bar; and
a lifting portion connected to said body portion, wherein said lifting portion is adapted to engage said slotted standards.

10. The apparatus of claim 9 wherein said lifting portion is hingedly connected to said body portion of said lifting fixture.

11. The apparatus of claim 9, wherein said lifting portion comprises a plurality of fingers extending from said body portion, said fingers being insertable into said slots defined in said slotted standards.

12. The apparatus of claim 1 wherein said jacking device comprises:
a motor;
a lifting screw rotated by said motor;
a support block threadedly connected to said rotatable screw;
at least one support rod extending upwardly from said support block; and
a support plate connected to an upper end of said support rod, said support plate being engageable with said lifting bar, wherein rotation of said lifting screw will cause said support block to move upwardly or downwardly on said screw, thereby moving said support plate and said lifting bar upwardly or downwardly when said support plate is engaged with said lifting bar.

13. The apparatus of claim 12 further comprising a support channel, the support channel comprising:
said support plate for engaging said lifting bar; and
side plates extending upwardly from said support plate for holding said lifting bar in place.

14. The apparatus of claim 12, said at least one support rod comprising a plurality of parallel rods extending upwardly from said support block.

15. A method of lifting multi-sided modular furniture, the method comprising:
placing at least one jacking device on a plurality of sides of said multi-sided modular furniture;
interconnecting said jacking devices with said plurality of sides; and
lifting said modular furniture as a unit with said jacking devices.

16. The method of claim 15 further comprising:
removing flooring beneath said modular furniture;
installing new flooring beneath said modular furniture; and
lowering said modular furniture as a unit with said jacking devices.

17. The method of claim 15, wherein said lifting step comprises:
actuating said jacking devices with a remote control; and
synchronously lifting said plurality of sides with said jacking devices.

18. The method of claim 15 further comprising monitoring an operating parameter relating to said lifting step to determine whether said modular furniture is being lifted as a unit.

19. The method of claim 18 wherein said operating parameter comprises a raising rate of each jacking device.

20. The method of claim 19 further comprising:
comparing said raising rates of each said jacking devices to a desired raising rate to determine whether said raising rates of said jacking devices deviate from said desired rate.

21. The method of claim 20 further comprising, if said comparing step indicates that a raising rate of any of said jacking devices deviate from said desired raising rate, adjusting said raising rates of said jacking devices so that the raising rates thereof are substantially equal to said desired raising rate.

22. The method of claim 18, wherein said operating parameter comprises a height to which the sides of said furniture have been lifted.

23. The method of claim 18, wherein said jacking devices comprise automatically operated jacking devices.

24. The method of claim 23, wherein said lifting step comprises sending a drive signal from a remote control device to each jacking device to cause said device to begin lifting.

25. The method of claim 23 wherein each said jacking device includes a respective lifting screw driven by a respective motor, said monitoring step comprising:
determining whether each said lifting screw of each said jacking device is rotating.

26. The method of claim 23 wherein said jacking devices include a transceiver for sending signals to and receiving signals from a remote control device and wherein said monitoring step comprising determining if each of said jacks are operating, the method further comprising, if any of said jacking devices are not operating, sending a shutdown signal from said remote control to all of said jacking devices.

27. The method of claim 15 further comprising:
comparing a raising rate for each of said jacking devices to a predetermined raising rate with a microcontroller; and
if the raising rate of a jacking device varies more than a desired amount from said predetermined rate, changing the raising rate of said jacking devices so that said raising rates are substantially the same as said predetermined rate.

28. The method of claim 27 said changing step comprising:
sending a shutdown signal from said microcontroller to a transceiver at each said jacking device to stop each said jacking device.

29. The method of claim 15, said modular furniture comprising a plurality of panels supported by a plurality of slotted standards, said interconnecting step comprising:
engaging at least one slotted standard on each of said plurality of sides with a lifting fixture, and engaging said lifting fixtures with said jacking device.

30. The method of claim 29, further comprising:
engaging a plurality of said slotted standards on each of said plurality of sides with said fixtures;
supporting said fixtures with lifting bars;
engaging each lifting bar with a said jacking device; and
lifting each said lifting bar with a respective said jacking device.

31. A method of lifting modular furniture, the modular furniture comprising a plurality of furniture panels and a plurality of slotted standards, the method comprising:
placing lifting fixtures in at least a portion of said plurality of slotted standards; and
lifting said fixtures with a plurality of automatic jacking devices to raise said modular furniture as a unit.

32. The method of claim 31 further comprising:
positioning said plurality of automatic jacking devices proximate said panels; and
interconnecting said lifting fixtures with said jacking devices, said lifting step comprising actuating said jacking devices to lift said lifting fixtures.

33. The method of claim 32 further comprising:
monitoring a raising rate of said jacking devices;
transmitting said raising rates to a microcontroller; and
determining in said microcontroller if the raising rates of the jacking devices are substantially the same as a predetermined raising rate.

34. The method of claim 33 further comprising:
if said raising rates are not substantially the same as said predetermined raising rate, stopping said jacking devices.

35. The method of claim 32 further comprising:
removing flooring from beneath said lifted modular furniture;
installing new flooring beneath said lifted modular furniture; and
lowering said modular furniture.

36. The method of claim 32, said lifting step comprising:
actuating all of said jacking devices simultaneously with a remote control.

37. Apparatus for lifting modular furniture comprised of a plurality of panels and a plurality of slotted standards, the apparatus comprising:
an extendible lifting bar having a length at least sufficient to span the distance between adjacent standards; and
a plurality of lifting fixtures supported by said lifting bar, said lifting fixtures being insertable in said slotted standards and said lifting bar being engageable by a jacking device for lifting and lowering said lifting bar.

38. The apparatus of claim 37 wherein said fixtures are slidable along said length of said lifting bar.

39. The apparatus of claim 37, said fixtures comprising a body portion hingedly connected to a lifting portion.

40. The apparatus of claim 37 wherein said bar has a generally rectangular cross section.

41. The apparatus of claim 37 wherein said bar comprises:
an outer bar defining a central opening; and
an inner bar slidably received in said outer bar.

42. The apparatus of claim 37 wherein said lifting fixture comprises a plurality of fingers insertable into slots defined by said slotted standards.

43. A method for lifting multi-sided modular furniture using a plurality of jacking devices interconnected to a plurality of sides of said modular furniture, the method comprising:
actuating the jacking devices with a controller to lift the modular furniture;
sensing an operating parameter related to said lifting of said modular furniture; and
communicating the sensed parameter to said controller.

44. The method of claim 44 wherein said jacking devices comprise electronically controlled screw jacks having a rotatable lifting screw, the operating parameter comprising a rate of rotation of said lifting screw.

45. The method of claim 44, further comprising:
comparing the rate of rotation of said lifting screw of each jack to a desired rotation; and
communicating a signal from said controller to each individual jack whose rate of rotation varies from a predetermined rate of rotation to adjust the rate of rotation so that each jack will lift at substantially the same rate.

46. The method of claim 45, the communicating step comprising sending a stop signal to all jacks so that each jack will stop advancing.

47. The method of claim 43 wherein:
said sensing step comprises sensing whether each jack is lifting, said communicating step comprising sending a signal from each jack to said controller to indicate whether each said jack is lifting.

48. The method of claim 47, wherein, if any of said jacks communicates a signal to indicate it is not lifting, sending a stop signal to each jacking device from said microcontroller to stop the jacking devices.

49. An office floor maintenance method for a floor supporting modular furniture having a plurality of panels connected by slotted standards, the modular furniture having a plurality of sides, the method comprising:
interconnecting a jacking device to a plurality of sides of said modular furniture; and
lifting said furniture as a unit;
performing a desired maintenance operation; and
lowering said furniture as a unit with said jacking devices.

50. The method of claim 49 wherein said performing step comprises removing and replacing flooring beneath said modular furniture.

51. The method of claim 49, the interconnecting step comprising interconnecting said jacking devices with said slotted standards.

52. The method of claim 49 wherein said lifting step comprises:
simultaneously actuating each of said plurality of said jacking devices with a controller.

53. The method of claim 52 further comprising:
determining whether each jack is advancing; and
stopping each jack if any of said jacks are not advancing.

54. A system for lifting multi-sided modular furniture as a unit comprising:
a plurality of electronically controlled jacking devices; and
a controller for remotely actuating each of said jacking devices to simultaneously advance each said jacking device so that said modular furniture may be lifted and lowered as a unit.

55. The system of claim 54, wherein each said jacking device comprises:
an electronically controlled ball screw jack; and
a support plate mounted to said jack to interconnect with said modular furniture.

56. The system of claim 54 further comprising:
a plurality of lifting bars;
at least one lifting fixture supported by each lifting bar, wherein said lifting fixtures interconnect with said modular furniture, and wherein each of said lifting bars may be engaged and lifted by one of said jacking devices.
